(19) United States
(12) Patent Application Publication
(10) Pub. No.: US 2013/0003428 A1
(43) Pub. Date: Jan. 3, 2013

(54) POWER SUPPLY SYSTEM AND ELECTRICAL DEVICE WITH SAME

(75) Inventors: LU-QING MENG, Shenzhen City (CN); HAI-LONG CHENG, Shenzhen City (CN); YONG-SONG SHI, Shenzhen City (CN); KUO-PIN LIN, Tu-Cheng (TW); CHUN-LUNG HUNG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/483,057

(22) Filed: May 30, 2012

(30) Foreign Application Priority Data
Jun. 28, 2011 (CN) 201110176625.X

(51) Int. Cl. H02M 1/36

(52) U.S. Cl. 363/49

(57) ABSTRACT

An exemplary power supply system is used to provide one or more operation voltages to a plurality of loads individually. The power supply system includes a timing circuit configured to control a starting time that the corresponding loads start to receive their corresponding operation voltages. The timing circuit includes a first capacitor arranged to be charged by the corresponding DC voltage, and the starting time is determined according to a charging characteristic of the first capacitor.

### BACKGROUND

1. Technical Field

The disclosure generally relates to a power supply system, and an electrical device such as a consumer electrical device using the power supply system.

2. Description of Related Art

Power supply systems are widely used in modern electrical devices, such as video players, mobile phones, and digital versatile disc (DVD) players, for example. These electrical devices generally include a plurality of function circuits to carry out corresponding operations. For example, a typical DVD player includes a video process circuit configured for processing video data, an audio process circuit configured for processing audio signals, and a driving circuit for driving a cassette mechanism of the DVD player. The power supply system of the DVD player is configured to convert an alternating current (AC) voltage to a plurality of direct current (DC) voltages, and output the DC voltages to the function circuits to power on the function circuits and enable them to operate. In normal use, the function circuits are not required to all start working at the same time. Therefore, a power supply system that can provide operation voltages to the function circuits at desired starting times of the function circuits is desired.

### BRIEF DESCRIPTION OF THE DRAWINGS

The accompanying drawings are included to provide a further understanding of the disclosure, and are incorporated in and constitute a part of the application. The drawings illustrate embodiments of the disclosure and, together with the description, serve to explain the principles of the disclosure.

FIG. 1 is a block diagram of an electrical device according to an embodiment of the present disclosure, the electrical device including a power supply system, the power supply system including a plurality of control sub circuits.

FIG. 2 is a diagram of one of the control sub circuits of FIG. 1.

FIG. 3 is a block diagram of part of an electrical device according to an alternative embodiment of the present disclosure, the electrical device including a power supply system.

### DETAILED DESCRIPTION

Reference will now be made in detail to the present preferred embodiments of the disclosure, examples of which are illustrated in the accompanying drawings. Wherever possible, the same reference numbers are used in the drawings and the description to refer to the same or like parts.

In the present disclosure, the electrical device can for example be a DVD player, a tablet computer, a notebook, or a mobile phone. Each such electrical device includes a plurality of function circuits that are capable of being enabled to work when receiving required DC operation voltages, and thereby are able to carry out corresponding functions. In the following description, the electrical device is a DVD player, as an example.

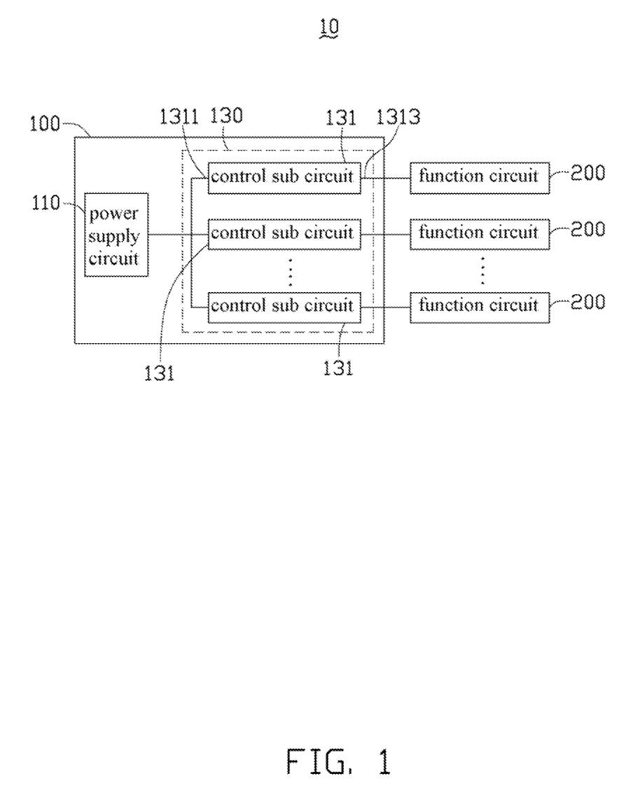

Referring to FIG. 1, the electrical device 10 includes a power supply system 100 and N function circuits 200, where N is equal to 2, 3, 4, . . . . That is, N is a natural number other than 1. The function circuits 200 act as loads, which receive DC operation voltages generated from the power supply system 100.

The power supply system 100 includes a power supply circuit 110 and a control unit 130. The power supply circuit 110 is configured to generate one or more required DC operation voltages either by rectifying an external AC voltage and then processing a DC-DC conversion, or by directly receiving a DC voltage from a battery and processing a DC-DC conversion. After processing the DC-DC conversion, the power supply circuit 110 outputs the DC operation voltages to the control unit 130. In the illustrated embodiment, the power supply circuit 110 supplies only one required DC operation voltage to the control unit 130.

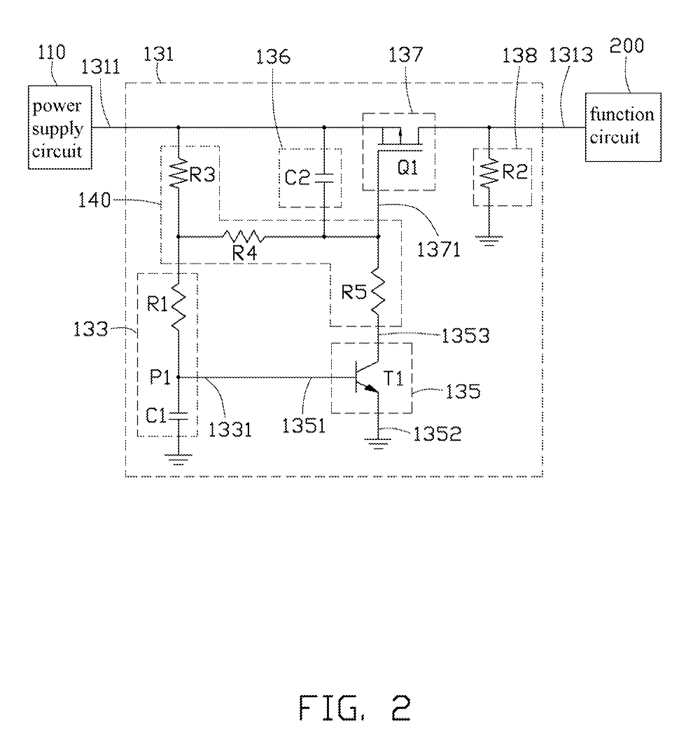

The control unit 130 includes N control sub circuits 131, where N is the same number as the number N of function circuits 200. Each control sub circuit 131 includes an input terminal 1311 connected to the power supply circuit 110 for receiving a corresponding operation voltage, and a voltage output terminal 1313 connected to a respective one of the function circuits 200 to enable the corresponding function circuit 200. The control sub circuit 131 is also configured to control a starting time that the corresponding function circuit 200 receives the operation voltage. The starting time is set by controlling (i.e., selecting) a charging characteristic (i.e., rate) of a first capacitor C1 (see FIG. 2) of the control sub circuit 131. In the following description, it is assumed that all the control sub circuits 131 are the same.

Referring to FIG. 2, a diagram of one of the control sub circuits 131 is shown. The control sub circuit 131 includes a timing circuit 133, a testing circuit 135, a switch circuit 137 and a protection circuit 140.

The timing circuit 133 is connected between the input terminal 1311 and ground, and includes a first resistor R1 and the first capacitor C1. The first resistor R1 and the first capacitor C1 are connected in series between the input terminal 1311 and ground. A node P1 between the first resistor R1 and the first capacitor C1 serves as a control signal output terminal 1331. When the operation voltage is input to the input terminal 1311, the first capacitor C1 is gradually charged by the operation voltage until a voltage of the first capacitor C1 has increased to a predetermined threshold value. Thereupon, the timing circuit 133 generates a control signal, and transmits the control signal to the testing circuit 135 via the control signal output terminal 1331. On the other hand, when the first capacitor C1 gradually discharges electricity until the voltage of the first capacitor C1 has decreased below the predetermined threshold value, the timing circuit 133 stops generating the control signal. In a case that the function circuit 200 requires a different starting time, a capacitance value of the first capacitor C1 and a resistance value of the first resistor R1 can be properly set accordingly.

The testing circuit 135 tests whether it is receiving the control signal by testing the voltage of the first capacitor C1. When the testing circuit 135 receives the control signal, the testing circuit 135 produces a switching-on signal and transmits the switching-on signal to the switch circuit 137. The testing circuit 135 includes a testing terminal 1351 connected to the control signal output terminal 1331, a signal input terminal 1352 connected to a ground terminal, and a signal output terminal 1353 outputting the switching-on signal to the switch circuit 137. In the embodiment, the testing circuit 135 is an n type transistor T1 which provides a low level signal (e.g. a ground signal) as the switching-on signal. Gate, emitting and base electrodes of the transistor T1 respectively serve as the testing terminal 1351, the signal input terminal 1352 and the signal output terminal 1353. The ground terminal connected to the signal input terminal 1352 functions as a signal generator, and is used to generate a ground signal which is subsequently output by the signal output terminal 1353 as the low level switching-on signal.

The switch circuit 137 is connected between the input terminal 1311 and the voltage output terminal 1313, and is configured to control whether the operation voltage is applied to the corresponding function circuit 200. In detail, when the switch circuit 137 is turned on under control of the switching-on signal, the operation voltage is transmitted to the function circuit 200 via the switch circuit 137, thereby enabling the function circuit 200 to work. Otherwise, the switch circuit 137 is turned off and the operation voltage is not transmitted to the function circuit 200. The switch circuit 137 can be for example a transistor Q1, or another suitable switch element, and has a control electrode 1371 connected to the signal output terminal 1353. In the embodiment, the switch circuit 137 is a transistor Q1. More particularly, the transistor Q1 is a p type transistor. Even more particularly, the p type transistor is a metal oxide semiconductor (MOS) transistor, that is, a P channel metal oxide semiconductor (PMOS) transistor. A gate electrode of the transistor Q1 serves as the control electrode 1371, a source electrode of the transistor Q1 is connected to the input terminal 1311, and a drain electrode of the transistor Q1 is connected to the voltage output terminal 1313.

Alternatively, the transistor Q1 is an n type transistor. More particularly, the n type transistor is a metal oxide semiconductor (MOS) transistor, that is, an N channel metal oxide semiconductor (NMOS) transistor. In such case, a signal generator (not shown) is used to generate a high level signal as the switching-on signal. The signal generator is connected to the signal input terminal 1352 of the testing circuit 135 (instead of the signal input terminal 1352 being connected to ground). The high level signal generated by the signal generator is input to the signal input terminal 1352, and is subsequently output by the signal output terminal 1353 of the testing circuit 135 to the switch circuit 137.

The protection circuit 140 acts as an overvoltage protector or an overcurrent protector, to protect the testing circuit 135 and the switch circuit 137. In the embodiment, the protection circuit 140 includes third, fourth and fifth resistors R3, R4 and R5 connected in series between the input terminal 1311 and the signal output terminal 1353 of the testing circuit 135.

During a time period after the input terminal 1311 stops receiving the operation voltage and before the voltage of the first capacitor C1 has decreased below the predetermined threshold value due to electricity discharge, the testing circuit 135 continues to output the switching-on signal and thereby maintains the switch circuit 137 in the switched-on state. Therefore, any residual electrical charges of the function circuit 200 can be discharged to ground via the switch circuit 137, the protection circuit 140 and the testing circuit 135. That is, the protection circuit 140 cooperates with the switched-on switch circuit 137 and the testing circuit 135 to form a first discharging circuit.

In this embodiment, the control sub circuit 131 can further include a second discharging circuit 138 connected between the voltage output terminal 1313 and ground. After the power supply circuit 110 stops working, any residual electrical charges of the function circuit 200 can also be discharged to ground via the second discharging circuit 138, thereby assisting the first discharging circuit to more quickly discharge the residual electrical charges of the function circuit 200. In the embodiment, the second discharging circuit 138 can be for example a second resistor R2.

In the embodiment, a second timing circuit 136 is provided in the control sub circuit 131. The second timing circuit 136 is connected between the input terminal 1311 and the signal output terminal 1353 of the testing circuit 135, and is configured to control an ending time for the supply of the operation voltage to the function circuit 200. The second timing circuit 136 includes a second capacitor C2, one end of which is connected to the input terminal 1311, and the other end of which is connected to the signal output terminal 1353 via the fifth resistor R5. The ending time can be set by controlling (i.e., selecting) a discharging characteristic (i.e., rate) of the second capacitor C2. Preferably, a time period of the discharging of the first capacitor C1 is greater than a time period of the discharging of the second capacitor C2.

In detail, when the operation voltage is applied to the input terminal 1131 and the testing circuit 135 is switched on, the second capacitor C2 is charged by the received operation voltage. During a time period after the input terminal 1311 stops receiving the operation voltage and the switch circuit 137 remains turned on, the second capacitor C2 discharges electricity to power the function circuit 200 via the switched-on switch circuit 137. A capacitance value of the second capacitor C2 and resistance values of the third and fourth resistors R3 and R4 can be properly set to achieve a desired time period of discharging of the second capacitor C2. Therefore, a desired ending time for the supply of the operation voltage to the function circuit 200 can be set easily.

Operation principles of the control sub circuit 131 are briefly described below:

When the control sub circuit 131 receives the operation voltage via the input terminal 1311, the operation voltage charges the first capacitor C1 to raise the voltage of the first capacitor C1, so that eventually the control signal output terminal 1331 of the timing circuit 133 outputs the control signal to the testing circuit 135. When the testing circuit 135 receives the control signal, the testing circuit 135 produces the switching-on signal to turn on the switch circuit 137. The function circuit 200 accordingly starts to receive the operation voltage via the switched-on switch circuit 137. The starting time that the function circuit 200 starts to receive the operation voltage can be set by properly choosing the capacitance value of the first capacitor C1 and the resistance value of the first resistor R1. At the same time, the second capacitor C2 is also charged by the received operation voltage.

When the input terminal 1311 stops receiving the operation voltage, the first capacitor C1 starts to discharge electricity to maintain the output of the control signal. Thus, the testing circuit 135 continues to output the switching-on signal to keep the switch circuit 137 turned on. At the same time, the second capacitor C2 discharges electricity to maintain the supply of power (i.e., the operation voltage) to the function circuit 200 via the switched-on switch circuit 137. The ending time for the supply of the operation voltage to the function circuit 200 can be set by properly choosing the capacitance value of the second capacitor C2 and the resistance values of the third and fourth resistors R3 and R4. After finishing the discharging of the second capacitor C2, any residual electrical charges of the function circuit 200 are able to not only be discharged to ground via the second discharging circuit 138, but also be discharged to ground via the first discharging circuit formed by the switched-on switch circuit 137, the protection circuit 140 and the testing circuit 135.

According to the above, each control sub circuit 131 in the control unit 130 can have a particular starting time of powering on the corresponding function circuit 200 set, by controlling the charging characteristic of the first capacitor C1. Therefore, the N function circuits 200 can have desired different starting times. Furthermore, a particular ending time of powering off each function circuit 200 can be set by controlling the discharging characteristic of the second capacitor C2 of the corresponding control sub circuit 131. The power supply system 100 is capable of not only providing the required operation voltage(s) to the corresponding function circuits 200, but also providing timing control to control the powering on and powering off of the function circuits 200 individually, as required.

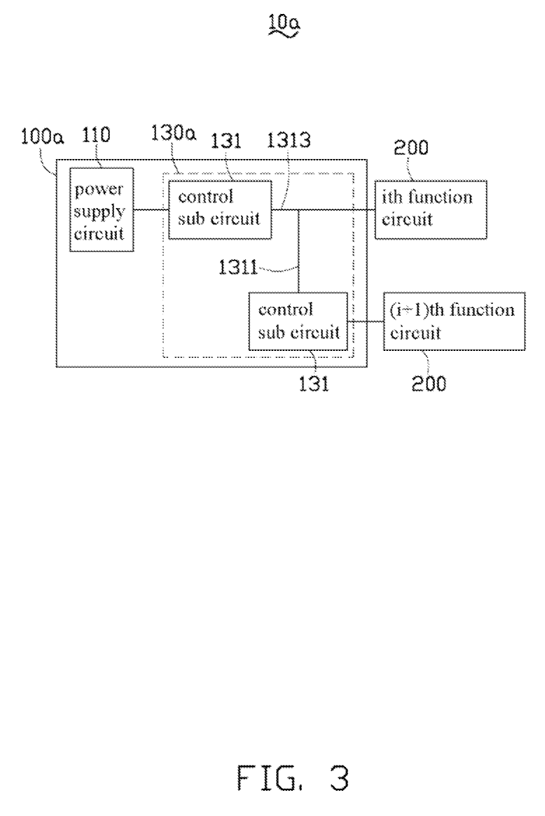

FIG. 3 shows part of an electrical device 10a according to an alternative embodiment of the present disclosure. The electrical device 10a includes a power supply system 100a. An input terminal 1311 of one control sub circuit 131 connected to an (i+1)th function circuit 200 is connected to the voltage output terminal 1313 of one control sub circuit 131 connected to an ith function circuit, where i is a natural number. With such configuration, the (i+1)th function circuit 200 has a later starting time than the ith function circuit.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of size and arrangement of parts within the principles of the disclosure to the full extent indicated by the broad general meaning of the terms in which the appended claims are expressed.

What is claimed is:

1. A power supply system for powering N loads, where N is a natural number greater than or equal to two, the power supply system comprising:
a power supply circuit configured for generating at least one direct current (DC) voltage; and
a control unit receiving the at least one DC voltage, the control unit comprising a plurality of voltage output terminals each arranged to be connected to a respective one of the N loads, and N control sub circuits, each control sub circuit comprising:
an input terminal for receiving a corresponding one of the at least one DC voltage;
a switch circuit connected between the input terminal and a corresponding one of the voltage output terminals, and comprising a control electrode configured for controlling a switched-on status of the switch circuit;
a first timing circuit connected to the input terminal for setting a starting time that the corresponding one of the N loads starts to receive the corresponding one of the at least one DC voltage after the input terminal begins to receive the corresponding one of the at least one DC voltage, the first timing circuit comprising a first capacitor arranged to be charged by the corresponding one of the at least one DC voltage, the starting time determined according to a charging characteristic of the first capacitor; and
a testing circuit connected between the first timing circuit and the control electrode of the switch circuit, the testing circuit configured to test a voltage of the first capacitor, produce a switching-on signal when the voltage of the first capacitor reaches a predetermined threshold value, and output the switching-on signal to the control electrode.

2. The power supply system of claim 1, wherein one end of the first capacitor is connected to ground, and the other end of the first capacitor is connected to the input terminal via a first resistor.

3. The power supply system of claim 1, wherein the testing circuit comprises a testing terminal connected to the first timing circuit for testing the voltage of the first capacitor, a signal input terminal connected to a signal generator and configured to receive the switching-on signal from the signal generator, and a signal output terminal connected to the control electrode for outputting the switching-on signal.

4. The power supply system of claim 3, wherein each control sub circuit further comprises a second timing circuit configured to control an ending time for the supply of the corresponding one of the at least one DC voltage to the corresponding one of the N loads, the second timing circuit comprises a second capacitor arranged to discharge electricity to the corresponding one of the N loads, and the ending time is set by controlling the discharging characteristic of the second capacitor.

5. The power supply system of claim 4, wherein one end of the second capacitor is connected to the input terminal, and the other end of the second capacitor is connected to the signal output terminal of the testing circuit.

6. The power supply system of claim 4, wherein each control sub circuit further comprises a protection circuit, and the protection circuit comprises a second resistor, a third resistor and a fourth resistor connected in series between the input terminal and the signal output terminal of the testing circuit.

7. The power supply system of claim 6, wherein the second capacitor is connected between the corresponding input terminal and a node between the third resistor and the fourth resistor.

8. The power supply system of claim 4, wherein the first capacitor discharges electricity during a time period after the corresponding input terminal stops receiving the corresponding one of the at least one DC voltage and before the voltage of the first capacitor decreases below the predetermined threshold value.

9. The power supply system of claim 8, wherein a time period of the discharging of the first capacitor is greater than a time period of the discharging of the second capacitor.

10. The power supply system of claim 1, wherein the N loads comprise an ith load requiring to be powered on at a first time and an (i+1)th load requiring to be powered on at a second time later than the first time, and the input terminal of one of the control sub circuits connected to the (i+1)th load is connected to the voltage output terminal of another one of the control sub circuits connected to the ith load, i being a natural number.

11. An electrical device, comprising:
N function circuits each operational when receiving a required direct current (DC) operation voltage, wherein N is a natural number other than one;
a power supply system configured to provide at least one required DC operation voltage to the N function circuits, the power supply system comprising:
a power supply circuit configured for generating the required at least one DC operation voltage; and
a control unit receiving the required at least one DC operation voltage, the control unit comprising a plurality of voltage output terminals each connected to a respective one of the N function circuits, and N control sub circuits, each control sub circuit comprising:
an input terminal for receiving a corresponding one of the at least one required DC operation voltage;
a switch circuit connected between the input terminal and a corresponding one of the voltage output terminals, and comprising a control electrode configured for controlling a switched-on status of the switch circuit;
a first timing circuit connected to the input terminal for setting a starting time that the corresponding one of the N function circuits starts to receive the corresponding one of the at least one required DC operation voltage, the first timing circuit comprising a first capacitor arranged to be charged by the corresponding one of the at least one required DC voltage, the starting time determined according to a charging characteristic of the first capacitor; and
a testing circuit connected between the first timing circuit and the control electrode of the switch circuit, the testing circuit configured to test a voltage of the first capacitor, produce a switching-on signal to turn on the switch circuit when the voltage of the first capacitor reaches a predetermined threshold value, and output the switching-on signal to the control electrode.

12. The electrical device of claim 11, wherein one end of the first capacitor is connected to ground, and the other end of the first capacitor is connected to the input terminal via a first resistor.

13. The electrical device of claim 11, wherein the testing circuit comprises a testing terminal connected to the first timing circuit for testing the voltage of the first capacitor, a signal input terminal connected to a signal generator and configured to receive the switching-on signal from the signal generator, and a signal output terminal connected to the control electrode for outputting the switching-on signal.

14. The electrical device of claim 13, wherein each control sub circuit further comprises a second timing circuit configured to control an ending time for the supply of power to the corresponding one of the N function circuits, the second timing circuit comprises a second capacitor arranged to discharge electricity to the corresponding one of the N function circuits, and the ending time is set by controlling the discharging characteristic of the second capacitor.

15. The electrical device of claim 14, wherein one end of the second capacitor is connected to the corresponding input terminal, and the other end of the second capacitor is connected to the signal output terminal of the testing circuit.

16. The electrical device of claim 14, wherein each control sub circuit further comprises a protection circuit, and the protection circuit comprises a second resistor, a third resistor and a fourth resistor connected in series between the input terminal and the signal output terminal of the testing circuit.

17. The electrical device of claim 16, wherein the second capacitor is connected between the input terminal and a node between the third resistor and the fourth resistor.

18. The electrical device of claim 14, wherein the first capacitor discharges electricity during a time period after the corresponding input terminal stops receiving the corresponding one of the at least one required DC operation voltage, and before the voltage of the first capacitor decreases below the predetermined threshold value.

19. The electrical device of claim 18, wherein a time period length of the discharging of the first capacitor is greater than a time period length of the discharging of the second capacitor.

20. The electrical device of claim 11, wherein the N function circuits comprise an ith function circuit requiring to be powered on at a first time and an (i+1)th function circuit requiring to be powered on at a second time later than the first time, and the input terminal of one of the control sub circuits connected to the (i+1)th function circuit is connected to the voltage output terminal of another one of the control sub circuits connected to the ith function circuit, i being a natural number.
